(19) United States
(12) Patent Application Publication
(10) Pub. No.: US 2021/0150847 A1
(43) Pub. Date: May 20, 2021

(54) MULTIMEDIA SYNCHRONIZATION SYSTEMS AND METHODS

(71) Applicant: IGT, Las Vegas, NV (US)

(72) Inventors: William M. Salivar, Reno, NV (US); Dwayne Nelson, Las Vegas, NV (US); Kevin Higgins, Reno, NV (US)

(21) Appl. No.: 16/684,071

(22) Filed: Nov. 14, 2019

(51) Int. Cl. G07F 17/32

(52) U.S. Cl. CPC G07F 17/323; G07F 17/3223

(57) ABSTRACT

The present disclosure relates generally to multimedia synchronization systems and methods. As a non-limiting example, a method is disclosed that includes receiving a data stream, processing the data stream and identifying a particular occurrence of an event based on processing the data stream. The method is further disclosed to include generating an excitement message based on the particular occurrence of the event and transmitting the excitement message to a gaming device thereby enabling the gaming device to perform an action based on receiving the excitement message.

### BACKGROUND

The present disclosure is generally directed to gaming devices and, in particular, toward systems and methods that enable multimedia synchronization between gaming devices and other display devices in a common area.

Casino floors are traditionally segregated into distinct areas with each area offering specific player experiences. For instance, casino floors usually have a specific area dedicated to table games, a different specific area dedicated to slot machines or Electronic Gaming Machines (EGMs), and yet another specific area dedicated to watching live sports and facilitating wagers for the same (e.g., a sports book).

### BRIEF SUMMARY

In certain embodiments, the present disclosure relates to a server, gaming device, and method that provide multimedia synchronization capabilities. In some embodiments, a synchronization server is provided, comprising: a data port that interfaces with a network used for communication with gaming devices; a processor coupled with the data port; and a computer-readable storage medium, coupled with the processor and comprising instructions stored thereon that are executable by the processor. In some embodiments, the instructions include: a set of instructions that process data signals received at the data port and identify a particular occurrence of an event based on processing the data signals; a set of instructions that generate an excitement message based on the particular occurrence of the event; and a set of instructions that transmit the excitement message to a gaming device thereby enabling the gaming device to perform an action based on receiving the excitement message.

In some embodiments, a gaming device is provided, comprising: a data port that interfaces with a network; an output device; a processor coupled with the data port and the output device; and a computer-readable storage medium, coupled with the processor and comprising instructions stored thereon that are executable by the processor. In some embodiments, the instructions include: a set of instructions that receive an excitement message via the data port, where the excitement message identifies an action for the gaming device to perform with the output device, and where the excitement message correlates the action to a particular occurrence of an event; and a set of instructions that cause the output device to perform the action.

In some embodiments, a method is provided, comprising: receiving, at a processor, a data stream; processing, with the processor, the data stream and identifying a particular occurrence of an event based on processing the data stream; generating, with the processor, an excitement message based on the particular occurrence of the event; and transmitting, via a data port in communication with the processor, the excitement message to a gaming device thereby enabling the gaming device to perform an action based on receiving the excitement message.

Additional features and advantages are described herein and will be apparent from the following Description and the figures.

### BRIEF DESCRIPTION OF THE SEVERAL VIEWS OF THE DRAWINGS

FIG. 1 is a block diagram depicting a gaming system in accordance with at least some embodiments of the present disclosure;

FIG. 2 is a block diagram depicting details of a gaming device in accordance with at least some embodiments of the present disclosure;

FIG. 3 is a block diagram depicting details of a synchronization server in accordance with at least some embodiments of the present disclosure;

FIG. 4 is a block diagram depicting additional details of a gaming device interacting with a synchronization server in accordance with at least some embodiments of the present disclosure;

FIG. 5A is a block diagram depicting a synchronization server coordinating operations of a plurality of gaming devices in accordance with at least some embodiments of the present disclosure;

FIG. 5B is a diagram depicting a map of a casino floor in accordance with at least some embodiments of the present disclosure;

FIG. 6A is a block diagram depicting an alternative system architecture in accordance with at least some embodiments of the present disclosure;

FIG. 6B is a block diagram depicting another alternative system architecture in accordance with at least some embodiments of the present disclosure;

FIG. 6C is a block diagram depicting another alternative system architecture in accordance with at least some embodiments of the present disclosure;

FIG. 7 is a flow diagram depicting a first method in accordance with at least some embodiments of the present disclosure;

FIG. 8 is a flow diagram depicting a second method in accordance with at least some embodiments of the present disclosure;

FIG. 9 is a flow diagram depicting a third method in accordance with at least some embodiments of the present disclosure;

FIG. 10 is a flow diagram depicting a fourth method in accordance with at least some embodiments of the present disclosure; and

FIG. 11 is a flow diagram depicting a fifth method in accordance with at least some embodiments of the present disclosure.

### DETAILED DESCRIPTION

Embodiments of the present disclosure will be described in connection with an event wagering and presentation system having one or multiple gaming devices that render information about events in various display presentations. The gaming devices may comprise any computing device, personal gaming device, mobile phone, mobile devices, Electronic Gaming Machine (EGM), sports wagering terminal, or collection of computing devices that receive and render information about events in a specific display presentation based on a number of criteria.

Embodiments of the present disclosure may provide systems and methods related to synchronizing device outputs based on events. In some embodiments, the systems and methods disclosed herein may synchronize device outputs in a casino environment relative to a sports wagering event or some other real-time event that is being displayed with a display device in the casino environment. A casino may have one or more EGMs, one or more other gaming devices (e.g., personal gaming devices carried by players), electronic table games, and other devices that are capable of producing visible and audible outputs. A casino may also have an event management system, such as a sports wagering host or sports wagering server, that is capable of providing the casino with wager opportunities, odds, play-by-play wagering events, (e.g., in-play or in-game wagering), and live video feeds of sporting events that can be wagered on by players in the casino or by players having a mobile gaming device. The player may be allowed to place wagers on such events at dedicated sports wagering terminals, at EGMs, at a mobile gaming device, or the like. For example, a player in the casino may be allowed to place a wager that a particular sports team will win a particular sports event. Alternatively or additionally, a player may place a wager that a particular result or outcome will occur during the sports event (e.g., a particular play will result in a particular outcome, a particular contestant will perform a particular act during the sports event, a particular series of outcomes will occur during the sports event, etc.).

Embodiments of the present disclosure provide systems and methods that will enhance a player's experience in a casino environment when viewing or wagering on such events. In some embodiments, output devices of gaming devices (e.g., EGMs, portable devices, sports betting terminals/kiosks, etc.) may be leveraged to enhance excitement within the casino environment based on the event that is being displayed in the casino. For instance, the sports book may be presenting a live video feed of a sports event that is currently under way. Players in the casino may place wagers on this sports event and when a particular outcome occurs during the event or when the event has completed, the output devices of the gaming devices may be leveraged to enhance the excitement surrounding the sporting event. More specifically, and without limiting embodiments described herein, a synchronization server may be configured to determine that a particular outcome has occurred during the sporting event and, in response thereto, generate and transmit one or more excitement messages to gaming devices in the casino. The gaming devices may receive the excitement message, process the excitement message, and, in response to processing the excitement message, produce an audible and/or visible output with appropriate output device(s), thereby enhancing the excitement surrounding the sporting event.

In some embodiments, outputs generated by gaming devices can be coordinated such that the collection of gaming devices present a unified and orchestrated presentation. The gaming devices may all play the same sound and flash lights in the exact same manner for player excitement. The gaming devices may alternatively or additionally perform animations and sequences that highlight one or more particular gaming devices, which draws attention to that gaming device. This synchronization can be achieved using a number of different methods. One possible method is to have a gaming device broadcast or multicast an excitement message to a communication network for delivery to other gaming devices. The other gaming devices may receive the message and begin the appropriate output sequence. For example, one gaming device might broadcast “Big Win” and start a particular sequence. The other gaming devices will receive the “Big Win” excitement message and do the same immediately upon receiving the excitement message. In another embodiment, the excitement message may contain a start time, which may be only a few seconds in the future. If all gaming devices have a synchronized or substantially synchronized clock, using a protocol such as Network Time Protocol (NTP), then the animation will start at the same time across multiple gaming devices.

Another possible method is to utilize a centralized synchronization server that instructs the gaming devices to perform a particular animation or sequence. The centralized synchronization server may be configured to download content and sequences to the terminals via one or more excitement messages and instruct one or more gaming devices to play the content to provide an exciting casino experience. In embodiments not necessarily related to the display of an event, the synchronization server may still be configured to trigger an animation across one or more gaming devices based upon an excitement message received from a gaming device where a player has made a winning wager or presented a winning ticket.

Embodiments of the present disclosure contemplate coordinating gaming device outputs with outcomes of events, such as events that can be wagered upon. For example, various different types of gaming devices in a casino can be synchronized or coordinated to product certain outputs based on an event being displayed in the sports book of a casino or being displayed at one or more display devices (e.g., television, monitor, etc.) of a casino. For instance, in a simple example, gaming devices may be configured to flash an exciting Green and Yellow pattern with their light emitters and play a cheering sound with their speakers when the Green Bay Packers (whose colors are Green and Yellow) score a touchdown. This is just a simple example.

In one embodiment the colors patterns may be configured to match the team who won the sporting event for which the player placed a winning wager on while in another embodiment the colors patterns include the colors of both teams involved in the sporting event.

In one embodiment many gaming devices may be configured to play a coordinated sequence when an outcome occurs in a sports event. For example, when a team scores, makes a first down, intercepts the ball, makes a 3-point score or any other significant sporting outcome, the system can play an animation (e.g., lights, sound, and/or video) via output devices of various gaming devices distributed across a casino floor. In one example, the system can play the school song from a team which happens to be a college team. The can be scaled such that a field goal animation is simpler and less exciting that a touch down animation.

In one embodiment the animation (or sound) may be triggered when there is a change in the team leading the sporting event. In another embodiment animation (or sound) may be provided that is triggered when the lead changes (increases or decreases).

In one embodiment, the animation might continue until the next sports wagering event or outcome during an event. For example, the Green Bay packers might have the ball on a 4th down with 1 yard from the goal line. This is an exciting and suspenseful event so the gaming devices might be instructed (e.g., via the excitement message(s)) to play intense music and a continuous sequence of lights until the next play happens.

In one embodiment, the gaming devices might stop animations during a timeout, halftime or delay in the game while in another embodiment the gaming devices might have a simple sequence they play during the delay. For example, during a time out the gaming devices might display the colors of the both teams in some simple display such alternating the colors for each gaming device on every other gaming device or displaying both team colors on all gaming devices without animating.

In one embodiment, only the gaming devices with a player betting on the event are configured to animate. For example, if Green Bay scores, only the gaming devices where players are seated that are betting on the game, or betting on Green Bay to win, will become animated.

In various embodiments, the system might have a tiered lighting or celebration capability. The sports wagering system might have various levels of celebration. Some celebrations might only involve a single gaming device where a player is wagering on the team. For example, Player A is seated at a gaming device and is wagering on the Raiders to win. When the Raiders get a first down, the gaming device where Player A is seated animates but the other gaming devices do not. Later the Raiders may score a touchdown, and all gaming devices may be configured to animate. In one embodiment, the levels of celebration could be tied to the amount wagered by a player on the game, or over a period of time, such as the past 5 minutes, past hour, etc. In another embodiment, the levels of celebration could be determined by the rank or tier of the player (e.g., whether the player has a VIP status or player loyalty account).

In one embodiment, the animation may be configured to show which players are winning or have won a sports wager. This could be a pattern that moves around the floor and lands on the player that just won a sports wager.

In one embodiment, one or more gaming devices may perform a sequence when a player makes a wager. For example, a player might bet that the next play will result in a touchdown. This might cause the terminal to flash the colors of the team on which he is betting, or display another lighting sequence to describe that the current player has committed a bet on the next play of the current event.

In one embodiment, gaming devices may be configured to show which players are betting on which team. For example, the Green Bay Packers (yellow and green) are playing the Dallas Cowboys (blue and white). Some gaming devices may display yellow and green because that player is betting on the Packers and other gaming devices display blue and white because those players are betting on the Cowboys. This lets other people see who likes which teams and increases the excitement.

All of the examples depicted and described herein could be implemented with video instead of or in addition to simple light emitters (e.g., LEDs, panel of LEDs, etc.). The gaming devices could display colors, patterns, video, etc. on one or more areas of one or more display devices or monitors. In one example, the gaming device display could alter the background colors, button colors or any other element on the screen in response to the sporting events or wagering events.

Embodiments of the present disclosure can also be configured to enhance the excitement associated with a ticket-in event at a gaming machine or kiosk. With a traditional ticketing system, the player inserts a voucher into a gaming device and the gaming device adds the ticket value to the player credit balance. This isn't a win and therefore there is no celebration.

With sports wagering, a winning ticket (also called a bet slip) is a win and can be celebrated. The present disclosure contemplates a ticket-in event triggering sounds, video animations, and/or lighting on the gaming device when inserted. The system could also be tiered such that a small win only animates the gaming device where the ticket was inserted but larger wins cause the gaming device to transmit an excitement message to other, neighboring gaming devices, (e.g., gaming devices belonging to a common bank or gaming devices across the entire casino floor) and the excitement messages may cause the multiple gaming devices to produce outputs that enhance the excitement associated with the ticket-in event. The tiered system could only play a sound for a small win, but play and animation with sound for larger wins. In one aspect, the player may be presented with the same types of win celebrations for a ticket-in event as would be played for a slot win event or progressive win event.

The gaming device could be also be connected to a larger display device, such as a sign, in a casino. The sign could celebrate the player's redemption of a winning ticket by itself, or in conjunction with the celebration occurring at the gaming device where the winning ticket was redeemed. In one embodiment, the sign could display general celebration animations, videos, and play sounds celebrating the redemption of a winning sports betting ticket. The sign may optionally, in addition to, or as an alternative to celebrating the player's win, display a leaderboard of big wins for the previous period of time (e.g., last hour, last day, last month, etc.) and the leaderboard may display the player's name in the sports betting system or player tracking system, or a name they manually enter into the gaming device. The player could optionally decline adding their win to the leaderboard.

These and other embodiments will now be described in further detail with reference to the appended figures.

### System

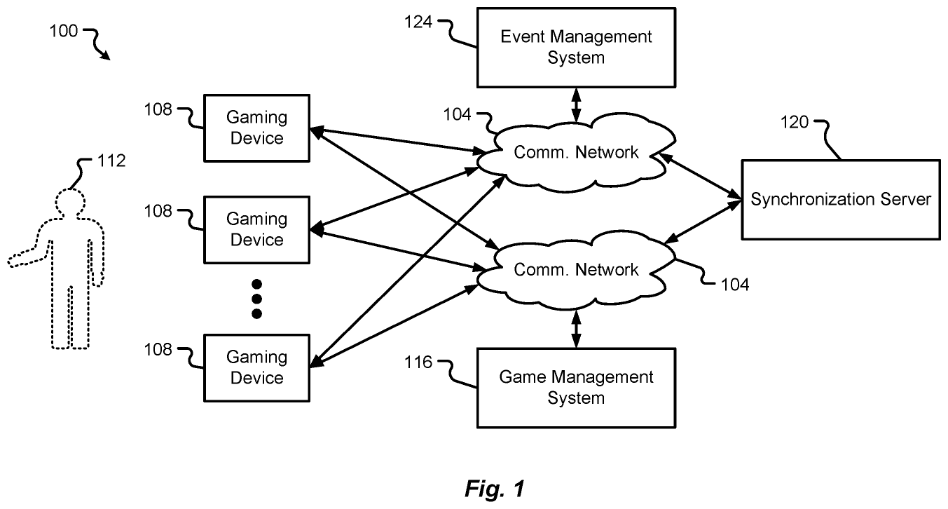

With reference initially to FIG. 1, details of an illustrative event wagering and presentation system 100 will be described in accordance with at least some embodiments of the present disclosure. The components of the event wagering and presentation system 100, while depicted as having particular instruction sets and devices, are not necessarily limited to the examples depicted herein. Rather, a system according to embodiments of the present disclosure may include one, some, or all of the components depicted in the system 100 and does not necessarily have to include all of the components in a single device. For instance, the components of a server may be distributed amongst a plurality of servers and/or other devices (e.g., gaming devices, EGMs, mobile devices, etc.) in the system 100 without departing from the scope of the present disclosure.

The event wagering and presentation system 100 is shown to include a communication network 104 that interconnects and facilitates machine-to-machine communications between one or multiple gaming devices 108, a game management system 116, a synchronization server 120, and an event management system 124. In some embodiments, the functionality of the synchronization server 120 may be provided in the game management system 116, in the event management system 124, in one or more gaming devices 108, or may be otherwise distributed across the system 100 in a manner other than the one depicted in FIG. 1. In some embodiments, the gaming devices 108, game management system 116, synchronization server 120, and event management server 124 may be configured to communicate using various nodes or components of the communication network 104.

The communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network 104 need not be limited to any one network type, and instead may be comprised of a number of different networks and/or network types. Moreover, the communication network 104 may comprise a number of different communication media such as coaxial cable, copper cable/wire, fiber-optic cable, antennas for transmitting/receiving wireless messages, and combinations thereof.

In some embodiments, the gaming devices 108 may be distributed throughout a single property or premises (e.g., a single casino floor) or the gaming devices 108 may be distributed among a plurality of different properties. In a situation where the gaming devices 108 are distributed in a single property or premises, the communication network 104 may include at least some wired connections between network nodes. As a non-limiting example, the nodes of the communication network 104 may communicate with one another using any type of known or yet-to-be developed communication technology. Examples of such technologies include, without limitation, Ethernet, SCSI, PCIe, RS-232, RS-485, USB, ZigBee, WiFi, CDMA, GSM, HTTP, TCP/IP, UDP, etc.

The gaming devices 108 may utilize the same or different types of communication protocols to connect with the communication network 104. It should also be appreciated that the gaming devices 108 may or may not present the same type of wagering interface, game, video presentation of an event, or alternative presentation of an event to a player 112. For instance, a first gaming device 108 may correspond to a gaming machine that presents a slot game to the player 112, the second gaming device 108 may correspond to a sports wagering terminal or sports wagering kiosk, a third gaming device 108 may correspond to a personal mobile device of a player 112, and other gaming devices 108 may present other types of games or a plurality of different games for selection and eventual play by a player 112. It may be possible for the some of the gaming devices 108 to communicate with one another via the communication network 104. In some embodiments, one or more of the gaming devices 108 may only be configured to communicate with a game management system 116 whereas other gaming devices 108 may be configured to communicate with the event management system 124 and/or synchronization server 120.

In some embodiments, the game management system 116 may correspond to a system used within a casino to manage slot games, video poker games, bingo games, keno games, or the like that are played on one or more of the gaming devices 108. In some embodiments, the event management system 124 may correspond to a system used within the casino to manage sports wagers placed by players 112 either at a sports desk or at a gaming device 108. Although not depicted, it should be appreciated that both systems 116, 124 may include one or multiple servers that execute instructions in connection with managing the games or wager capabilities made available at the gaming devices 108. In some embodiments, the game management system 116 operates independent of the event management system 124. In some embodiments, player 112 activities registered with the game management system 116 may not necessarily be registered with the event management system 124.

In some embodiments, the game management system 116 may utilize one or more databases to track player 112 activity with respect to the gaming devices 108. For instance, if the game management system 116 corresponds to a PTS, then games played at the gaming devices 108, credits wagered in a slot game, credits won in a slot game, etc. may correspond to the types of first player 112 activities tracked by the game management system 116. Conversely, the event management system 124 may utilize different databases to track outcomes of events, wagers placed on events, results of wagers placed on events, locations of players 112 within a casino and the wagers placed by those players 112 on an event, etc. For instance, if the event management system 124 corresponds to a sports wagering system, then wagers placed on sporting events, results of wagers placed, and games being watched by a player 112 at the gaming device 108 may correspond to the types of player 112 activities tracked by the event management system 124.

The synchronization server 120, as will be described in further detail herein, may be configured to receive information regarding events being managed by the event management system 124 and synchronize outputs made at gaming devices 108 to enhance the player's 112 experience associated with viewing such events. In some embodiments, the synchronization server 120 may be configured to determine rooting preferences of a player 112 or multiple players 112 in a casino environment (e.g., within a common area or on a casino floor) and may customize outputs produced by the gaming devices 108 based on the rooting preferences and based on outcomes of the events being managed by the event management system 124. As a non-limiting example, wagers placed by players 112 on sporting events may be known by the event management system 124 and communicated to the synchronization server 120. With such wager information, the synchronization server 120 may be configured to generate and transmit excitement messages to appropriate gaming devices 108 during an event that is the subject of a player's 112 wager to enhance the player's experience within the casino.

A gaming device 108 may correspond to a type of device that enables user interaction in connection with making wagers, watching events such as live competitive contests, and/or playing games of chance. For instance, the gaming devices 108 may correspond to a type of device that enables a player 112 to wager on, and watch, events via a display device of the gaming device 108. A gaming device 108 may include any type of known gaming device such as a slot machine, a table game, an electronic table game (e.g., video poker), a skill-based game, etc. The gaming device 108 can be in the form of an EGM, virtual gaming machine, video game gambling machine, etc. One particular type of gaming device 108 may include mobile devices such as portable communications devices, personal computers, and/or other microprocessor-enabled devices having memory and communications interfaces. Non-limiting examples of a mobile device include a cellular phone, a smartphone, a tablet, a wearable device, an augmented reality headset, a virtual reality headset, a laptop, a Personal Computer (PC), or the like. In addition to playing games and wagering on a gaming device 108, the players 112 may also be allowed to watch live sporting events on a respective mobile device, on a separate display device (e.g., a television or monitor), or combinations thereof.

### Gaming Device

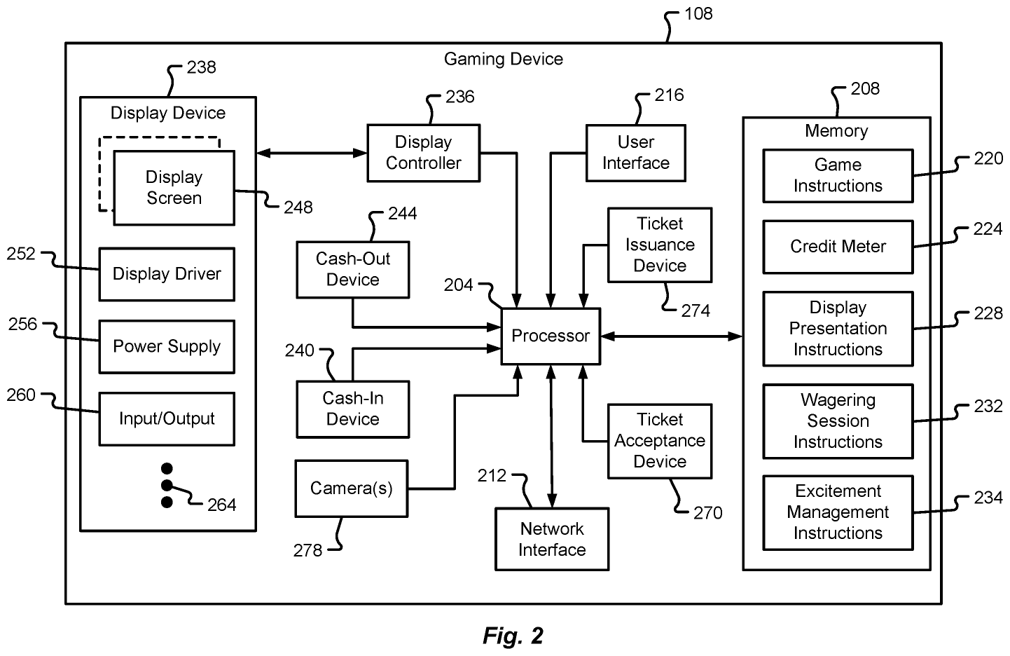

With reference now to FIG. 2, additional details of a gaming device 108 will be described in accordance with at least some embodiments of the present disclosure. While depicted as a gaming device 108, it should be appreciated that some or all of the components of a single gaming device 108 may be distributed across multiple gaming devices 108 (of the same or different type) without departing from the scope of the present disclosure.

The gaming device 108 is depicted to include a processor 204, memory 208, a network interface 212, a user interface 216, a display controller 236, a display device 238, a cash-in device 240, a cash-out device 244, a ticket acceptance device 270, a ticket issuance device 274, and one or more cameras 278. In some embodiments, the processor 204 may correspond to one or many microprocessors, CPUs, microcontrollers, or the like. The processor 204 may be configured to execute one or more instruction sets stored in memory 208.

The nature of the network interface 212 may depend upon whether the network interface 212 is provided in a gaming device 108 or a mobile device. In some embodiments, the network interface 212 may include at least one port that facilitates a physical connection and data connection with the communication network 104. Examples of a suitable network interface 212 include, without limitation, an Ethernet port, a USB port, an RS-232 port, an RS-485 port, a NIC, an antenna, a driver circuit, a modulator/demodulator, etc. The network interface 212 may include one or multiple different network interfaces depending upon whether the gaming device 108 is connecting to a single communication network 104 or multiple different types of communication networks 104. For instance, the gaming device 108 may be provided with both a wired network interface and a wireless network interface without departing from the scope of the present disclosure. In some embodiments, the network interface 212 may include different communications ports that interconnect with various input/output lines. For example, a first communications port may provide an interconnection (e.g., via at least one Ethernet, RJ-11, RJ-45, or other communications port) between the network interface 212 and the synchronization server 120, or other servers in the event wagering and presentation system 100. Continuing this example, a second communications port of the network interface 212 may provide an interconnection between the network interface 212 and the synchronization server 120. The network interface 212 may further include a third communication port that provides connectivity with the game management system 116. In this manner, the gaming device 108 may allow for the transfer of information from one or more of the servers 120 and systems 116, 124.

The user interface 216 may correspond to any type of input and/or output device that enables the player 112 to interact with the gaming device 108. As can be appreciated, the nature of the user interface 216 may depend upon the nature of the gaming device 108. For instance, if the gaming device 108 includes a slot machine game, then the user interface 216 may include one or more reels, or virtual rendered reels, with symbols provided thereon, one or more lights or LED displays, one or more depressible buttons, a lever or “one armed bandit handle,” a speaker, or combinations thereof. If the gaming device 108 is a digital or mobile device, then the user interface 216 may include one or more touch-sensitive displays, LED/LCD display screens, buttons, switches, etc.

The memory 208 may include one or multiple computer memory devices that are volatile or non-volatile. The memory 208 may be configured to store instruction sets that enable player 112 interaction with the gaming device 108, that enable game play at the gaming device 108, that enable viewing of event presentations at the gaming device 108, that enable coordination with the synchronization server 120, and that enable other enhanced excitement functions to be provided at the gaming device 108. Examples of instruction sets that may be stored in the memory 208 include a game instruction set 220, a credit meter 224, a display presentation instruction set 228, a wagering session instruction set 232, and an excitement management instruction set 234.

In some embodiments, the game instructions 220, when executed by the processor 204, may enable the gaming device 108 to facilitate one or more games of chance or skill and produce interactions between the player 112 and the game of chance or skill. In some embodiments, the game instructions 220 may include subroutines that present one or more graphics to the player 112 via the user interface 216, subroutines that calculate whether a particular game wager has resulted in a win or loss during the game of chance or skill, subroutines for determining payouts for the player 112 in the event of a win, subroutines for exchanging communications with a connected server (e.g., game management server, synchronization server 120, or the like), subroutines for enabling the player 112 to engage in a game using their mobile device 142, and any other subroutine or set of instructions that facilitate gameplay at or in association with the gaming device 108.

The credit meter 224 may correspond to a data structure within the gaming device 108 that facilitates a tracking of activity at the gaming device 108. In some embodiments, the credit meter 224 may be used to store or log information related to various player 112 activities and events that occur at the gaming device 108. The types of information that may be maintained in the credit meter 224 include, without limitation, player information, available credit information, wager amount information, and other types of information that may or may not need to be recorded for purposes of accounting for wagers placed at the gaming device 108 and payouts made for a player 112 during a game of chance or skill played at the gaming device 108. In some embodiments, the credit meter 224 may be configured to track coin-in activity, coin-out activity, coin-drop activity, jackpot paid activity, bonus paid activity, credits applied activity, external bonus payout activity, ticket/voucher in activity, ticket/voucher out activity, timing of events that occur at the gaming device 108, and the like. In some embodiments, certain portions of the credit meter 224 may be updated in response to outcomes of a game of chance or skill played at the gaming device 108 and/or in response to occurrences or outcomes of incidents associated with events the player 112 bet on at the gaming device 108 as part of a wagering session. In some embodiments, the credit meter 224 may be updated depending upon whether the gaming device 108 is issuing a ticket/voucher, being used as a point of redemption for a ticket/voucher, and/or any other activity associated with a ticket/voucher. Some or all of the data within the credit meter 224 may be reported to the game management system 116, for example, if such data applies to a centrally-managed game and/or a status of a ticket/voucher. As an example, the number, value, and timing of wagers placed by a particular player 112 and payouts on such wagers may be reported to the game management system 116.

The display presentation instruction set 228, when executed by the processor 204, may enable the gaming device 108 to provide various display and/or auditory presentations for a game played on the gaming device 108. The display presentation instruction set 228 may also be configured to produce particular outputs with output devices of the gaming device 108 based on excitement messages received and processed by the excitement management instruction set 234. For instance, based on an event, or an outcome of an event, the excitement management instruction set 234 may receive an excitement message from an external device (e.g., another gaming device 108 or the synchronization server 120). In response to receiving the excitement message, the excitement management instruction set 234 may determine desired outputs to be produced at the gaming device 108 and such information may be communicated to the display presentation instruction set 228. The display presentation instruction set 228 may be configured to produce one or more outputs that cause the user interface 216 and/or display device 238 to generate an audible and/or visible output for the player 112. Said another way, the display presentation instruction set 228 may render one or more alerts, alarms, winning graphics, flashing lights, losing graphics, etc. in accordance with data received in one or more excitement messages. As will be discussed in further detail herein, because such excitement messages may be generated and transmitted in response to events or outcomes of events being displayed at other display devices in a casino, the gaming device 108 is enabled to enhance the player 112 experience associated with the presentation of such events. The display presentation instruction set 228 may provide one or more commands to the display controller 236 and the display device 238 to control the rendered output throughout a player's 112 interaction, and/or wagering session, with the gaming device 108.

The wagering session instruction set 232, when executed by the processor 204, may enable the gaming device 108 to receive information from an event management system 124 (e.g., a sports wagering system), receive input from a player 112 (e.g., via the user interface 216, etc.) placing a bet on an outcome associated with an event (e.g., on one or more incidents in the event, etc.). In some embodiments, the wagering session instruction set 232 may send a signal defining the bet placed to the event management system 124 via the network interface 212 (e.g., a data port) of the gaming device 108. The wagering session instruction set 232 may command the one or more cameras 278 of the gaming device 108 to take at least one image of the player 112 placing the bet (e.g., to confirm that the player 112 is authorized to place the bet, etc.). In any event, the wagering session instruction set 232 may work in conjunction with the display presentation instruction set 228 to render betting information (e.g., wagering opportunities, odds, etc.) obtained from the event management system 124 to a display device 238 of the gaming device 108.

The gaming device 108 may include one or more display devices 238 configured to render information, live video, communications windows, wagering interface windows, games, interactive elements, and/or other visual output to one or more display screens 248. The gaming device 108 may include one or more display controllers 236 configured to control an operation of the display device 238. This operation may include the control of input (e.g., player 112 input via the user interface 216, command input via the instruction sets in memory 208, combinations thereof, etc.), output (e.g., display, rendered images, visual game behavior, etc.) and/or other functions of the display device 238.

The display device 238 may one or more display screens 248 that are configured to selectively activate pixels and/or display elements to render one or more games, windows, indicators, interactive elements, icons, characters, lights, images, etc. Examples of the display screen 248 may include, but are in no way limited to, a liquid crystal display (LCD), a light-emitting diode (LED) display, an electroluminescent display (ELD), an organic LED (OLED) display, and/or some other two-dimensional and/or three-dimensional display. In some embodiments, the one or more display screens 248 may be separated into a main display and a secondary display.

The display device 238 may include a display driver 252, a power supply 256, an input/output 260, and/or other components 264 configured to enable operation of the display device 238. The display driver 252 may receive commands and/or other data provided by the processor 204 and one or more of the instruction sets in memory 208. In response to receiving the commands, the display driver 252 may be configured to generate the driving signals necessary to render the appropriate images to the display screen 248. The power supply 256 may provide electric power to the components of the display device 238. In some embodiments, the power supply 256 may include a transformer and/or other electronics that prevent overloading, condition power signals, and/or provide backup power to the display device 238. The input/output 260 may correspond to one or more connections for receiving or exchanging information and/or video from components of the gaming device 108. The input/output 260 may include an interconnection to the network interface 212. For example, the input/output 260 may include a high-definition multimedia interface (HDMI) input, Ethernet, composite video, component video, H.264, or other video connection.

The cash-in device 240 may include a bill acceptor, a coin acceptor, a chip acceptor or reader, or the like. In some embodiments, the cash-in device may also include credit card reader hardware and/or software. The cash-out device 244, like the ticket issuance device 270, may operate and issue cash, coins, tokens, or chips based on an amount indicated within the credit meter 224. In some embodiments, the cash-out device 244 may include a coin tray or the like and counting hardware configured to count and distribute an appropriate amount of coins or tokens based on a user's 112 winnings or available credit within the credit meter 224.

Because the gaming device 108 may be used for the acceptance and issuance of tickets/vouchers, the gaming device 108 may be provided with appropriate hardware to facilitate such acceptance and issuance. Specifically, the gaming device 108 may be provided with a ticket acceptance device 270 that is configured to accept or scan physically-printed tickets/vouchers and extract appropriate information therefrom. In some embodiments, the ticket acceptance device 270 may include one or more machine vision devices (e.g., a camera, IR scanner, optical scanner, barcode scanner, etc.), a physical ticket acceptor, a shredder, etc. The ticket acceptance device 270 may be configured to accept physical tickets and/or electronic tickets without departing from the scope of the present disclosure. An electronic ticket/voucher may be accepted by scanning a one-dimensional barcode, two-dimensional barcode, or other type of barcode or quick response (QR) code displayed by a player's 112 mobile device, for example.

The ticket issuance device 274 may be configured to print or provide physical tickets/vouchers to users 112. In some embodiments, the ticket issuance device 274 may be configured to issue a ticket/voucher consistent with an amount of credit available to a player 112, possibly as indicated within the credit meter 224.

The gaming device 108 may include at least one camera 278, or image capture device, that is configured to capture still and/or video images in proximity to the gaming device 108. The camera 278 may include, or be associated, with additional devices, such as light sources, flashes, infrared emitters, etc., to provide a clear image capture environment. As provided herein the camera 278 may be controlled by the processor 204 in conjunction with signals from the wagering session instruction set 232 and/or other instruction sets in memory 208.

### Synchronization Server

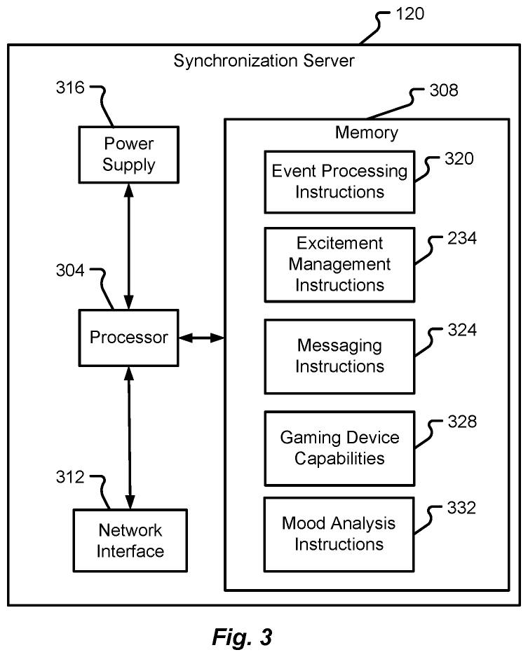

With reference now to FIG. 3, additional details of a synchronization server 120 will be described in accordance with at least some embodiments of the present disclosure. The synchronization server 120 is shown to include a processor 304, memory 308, and a network interface 312. These resources may enable functionality of the synchronization server 120 as will be described herein. For instance, the network interface 312 provides the synchronization server 120 with the ability to send and receive communication packets or the like over the communication network 104. The network interface 312 may be provided as a network interface card (NIC), a Slot Machine Interface Board (SMIB), a network port, a data port, a modem, drivers for the same, combinations thereof, and the like. Communications between the components of the server 116 and other devices connected to the communication network 104 may all flow through the network interface 312. For instance, excitement messages may flow into and out of the network interface 312.

The processor 304 may correspond to one or many computer processing devices. For instance, the processor 304 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 304 may be provided as a microprocessor, Central Processing Unit (CPU), or plurality of microprocessors that are configured to execute the instructions sets stored in memory 308. Upon executing the instruction sets stored in memory 308, the processor 304 enables various functions of the synchronization server 120.

The memory 308 may include any type of computer memory device or collection of computer memory devices and may be volatile or non-volatile. Non-limiting examples of memory 308 include Random Access Memory (RAM), Read Only Memory (ROM), flash memory, Electronically-Erasable Programmable ROM (EEPROM), Dynamic RAM (DRAM), etc. The memory 308 may be configured to store the instruction sets depicted in addition to temporarily storing data for the processor 304 to execute various types of routines or functions.

The memory 308 may store various data and instruction sets that allow the synchronization server 120 to provide multimedia synchronization capabilities between various gaming devices 108 with respect to events that occur beyond such gaming devices 108. Examples of such events that may be subject to processing by the synchronization server 120 include any type of wagerable event. As provided above, information regarding these event(s) may be received from a gaming device 108, from an event management system 124, or from combinations thereof. The types of events that may be processed by the synchronization server 120 include, but are in no way limited to, sporting matches, games, races (e.g., horse races, dog races, political races, etc.), competitions, boxing events, fighting events (e.g., boxing, mixed martial arts (MMA), wrestling, judo, karate, etc.), entertainment events, organized events, shows, combinations thereof, and/or discrete wagering opportunities on incidents associated with the same. Alternatively or additionally, events may correspond to one or more actions or activities that occur at a gaming device 108 (e.g., ticket-in events, win events, wager events, etc.). In some embodiments, the synchronization server 120 may receive information from one or more gaming devices 108 regarding wagers made on events or this information may be received from the event management system 124. This information may define a wager description, a particular outcome, a bet amount, and/or timing associated with the wager.

Illustrative instruction sets that may be stored in memory 308 include, without limitation, an event processing instruction set 320, an excitement management instruction set 234, a messaging instruction set 324, and a mood analysis instruction set 332. The memory 308 may also be configured to store data related to gaming device capabilities 328. Such information may be stored in a table format, in a database format, in a list format, or combinations thereof. Functions of the server 120 enabled by these various instruction sets will be described in further detail herein. It should be appreciated that the instruction sets depicted in FIG. 1 may be combined (partially or completely) with other instruction sets or may be further separated into additional and different instruction sets, depending upon configuration preferences for the server 120. Said another way, the particular instruction sets depicted in FIG. 1 should not be construed as limiting embodiments described herein.

The event processing instruction set 320 may correspond to an instruction set that when executed by the processor 304 enables the synchronization server 120 to receive and process various messages received at the network interface 312. In some embodiments, the event processing instructions 320 may be configured to receive one or more messages describing an event, wagers placed on an event, or an outcome of an event. Such messages may be received via the communication network 104 and may have been transmitted by a gaming device 108, by the game management system 116, and/or by the event management system 124. The event processing instructions 320 may be configured to process data signals received at the network interface 312 and identify a particular occurrence of an event based on the processing of the data signals. Information regarding the particular occurrence of an event may then be transferred to the excitement management instruction set 234 for further processing.

The excitement management instruction set 234 may be configured to generate one or more excitement messages based on the particular occurrence of an event identified by the event processing instruction set 320. In some embodiments, the excitement management instruction set 234 may be configured to identify particular targets for excitement messages and provide such information to the messaging instruction set 324. Upon receiving the excitement message(s) and identified targets for an excitement message, the messaging instruction set 324 may cause the excitement message(s) to be transmitted to the identified targets via the network interface 312. As discussed herein, the excitement message(s) may enable the recipient device (e.g., the target device) to perform one or more actions (e.g., produce one or more visible and/or audible outputs) consistent with the instructions included in the excitement message. In some embodiments, the excitement message(s) may include specific actions to be performed by a gaming device, specific timings for such actions, etc.

In some embodiments, the excitement management instruction set 234 may be configured to generate a generic excitement message for transmission to multiple gaming devices 108 (e.g., for transmission via a broadcast capability). Upon receiving a generic excitement message, each recipient gaming device 108 may make a self-determination of an action to perform based on receiving the generic excitement message and based on its own knowledge of output device capabilities. Alternatively or additionally, the excitement management instruction set 234 may utilize the gaming device capabilities 328 to determine, prior to generating and sending an excitement message, output devices included in specific gaming devices 108. In some embodiments, this knowledge maintained in the gaming device capabilities 328 may be maintained and updated when new gaming devices 108 are installed/commissioned, when gaming devices 108 are updated, when gaming devices 108 are moved, and/or when gaming devices 108 are decommissioned. The gaming device capabilities 328 may describe specific output capabilities of gaming devices 108 and/or the output devices included in such gaming devices 108. With reference to the gaming device capabilities 328, the excitement management instruction set 234 may be configured to generate gaming device-specific excitement messages that identify a particular output to be provided by a particular gaming device 108. This gaming device-specific excitement message may also include a desired timing for the particular output. When coordinating outputs of multipole gaming devices 108, the synchronization server 120 may transmit multiple, different, gaming device-specific excitement messages to different gaming devices 108 to cause each gaming device 108 to produce different outputs, thereby enhancing the excitement associated with an event in a casino.

The mood analysis instruction set 332, when executed by the processor 304, may enable the synchronization server 120 to determine rooting preferences of an individual player 112, determine rooting preferences of a group of players 112, determine a mood of a player or multiple players based on the rooting preferences and outcomes of an event, determine a location of players 112 and their associated rooting preferences, identify gaming devices 108 within a predetermined proximity of players 112 having a known mood or rooting preference, and provide such mood and rooting preference information to the excitement management instruction set 234. The excitement management instruction set 234 may be configured to process outputs of the mood analysis instruction set 332 to customize or control certain gaming devices 108 in accordance with the determined rooting preferences and moods of players 112 in proximity of gaming devices 108. For instance, the combination of the mood analysis instruction set 332 and excitement management instruction set 234 may enable the synchronization server 120 to control a cluster of gaming devices 108 based on a mood or rooting preference of players 112 in proximity with the cluster of gaming devices 108 and cause the cluster of gaming devices 108 to produce outputs that coincide with exciting moments during an event and that match the rooting preferences or mood. As used herein, a rooting preference may be determined based on wagers placed by players 112 whereas a mood may be determined based on a combination of the rooting preference and an outcome of an event. For instance, two different players 112 or player groups may have different rooting preferences for the same sporting event (e.g., one player 112 is rooting for one team whereas another player 112 is rooting for a different team). A single outcome of an event (e.g., an end of the game outcome) may cause one of the teams to be a losing team whereas the other team is a winning team. The player 112 that won a wager for the winning team may be determined to have a positive/excited mood whereas another player 112 that won their wager on the same event may have a sad mood. The mood analysis instruction set 332 and excitement management instruction set 234 may work in concert to cause gaming devices 108 near the winning player 112 to output additional excitement-enhancing sounds and lights (e.g., loud sounds and flashing lights) whereas gaming devices 108 near the losing player 112 may be caused to output soothing or sad sounds and lights (e.g., soft sounds and dimmed lights).

### Possible System Architectures

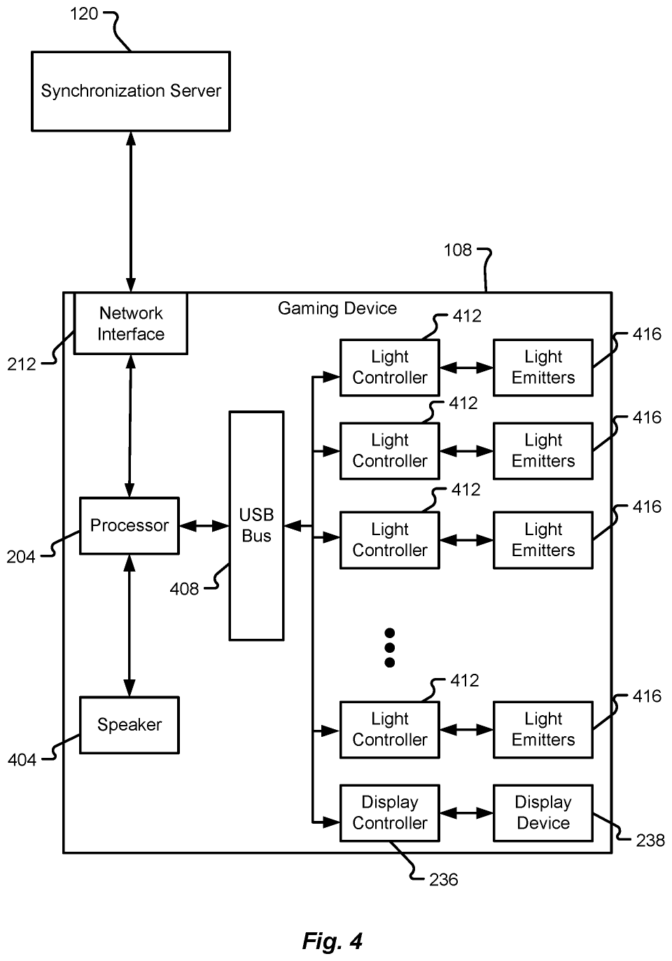

With reference now to FIGS. 4-6C, additional details of various system 100 architectures will be described in accordance with at least some embodiments of the present disclosure. Referring initially to FIG. 4, additional details of a gaming device 108 and its interactions with a synchronization server 120 will be described in accordance with at least some embodiments of the present disclosure.

The gaming device 108 is shown to be in communication with the synchronization server 120 via the network interface 212. The processor 204 is connected with a speaker 404 and a plurality of additional output devices (e.g., light emitters 416 and a display device 238) via a serial data bus 408. In the depicted embodiment, the speaker 404 and light emitters 416 may correspond to specific but non-limiting examples of a user interface 216. It should be appreciated that control signaling between the processor 204 and the light emitters 416 may be handled using a protocol native to the serial data bus 408. In some embodiments, the processor 204 may communicate a single command to multiple light controllers 412 to simultaneously cause the light emitters 416 to produce a desired output (e.g., light up or flash at a desired time for a desired duration). The processor 204 can alternatively or additionally cause the speaker 404 to produce an audible output based on an excitement message received from the synchronization server 120.

In some embodiments, the gaming device 108 is responsive to output commands received from the synchronization server 120 in the form of excitement messages. The excitement messages may be received at the processor 204, processed by the processor 204, and then used to determine which actions should be taken with respect to the speaker 404, light emitters 416, and display device 238. It should be appreciated that the processor 204 may be configured to direct individual commands to particular light emitters 216 based on instructions contained in an excitement message. For instance, the processor 204 may cause of the light emitters 416 to emit light of a first color and another of the light emitters 416 to emit light of a second, different, color. Other parameters that may be controlled by the processor 204 include, without limitation, light intensity/brightness, light duration, flashing frequency, timing with which lighting starts and ends, speaker 404 volume, timing of audible sounds produced by the speaker 404, etc. The processor 204 may be configured to control the internal components of the gaming device 108 in accordance with instructions received from the synchronization server 120. In some embodiments, an excitement message may direct the gaming device 108 to produce a sequence of audible and/or visible outputs via the light emitters 416, display device 238, and speaker 404. The processor 404 may determine the appropriate commands to send to the speaker 404, light controllers 412, and display controller 236 based on the excitement message and parameters defined within the excitement message. Each output device (e.g., the speaker 404, light emitter(s) 416, and display device 238) may be controlled by the processor 204 to produce an audible and/or visible output that enhances an excitement surrounding an event that has occurred external to the gaming device 108.

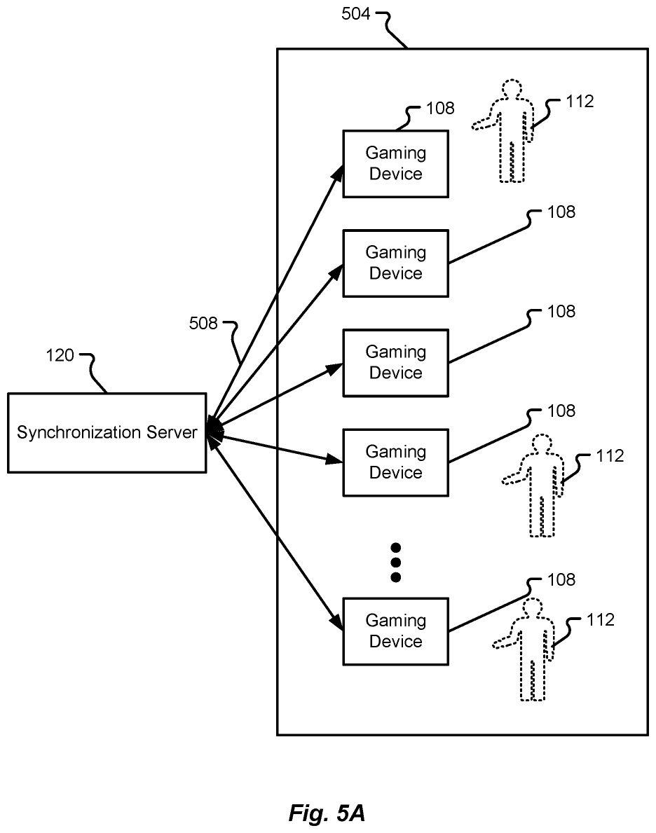

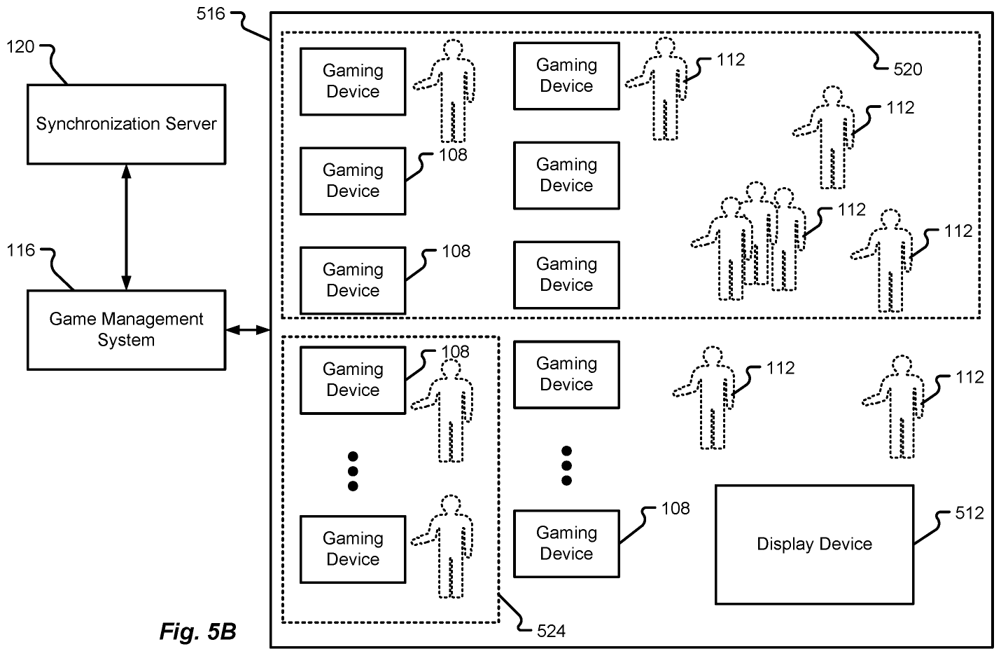

FIG. 5A illustrates that a single synchronization server 120 may be configured to control multipole gaming devices 108, which may be considered a cluster of gaming devices 504 to the synchronization server 120. The cluster of gaming devices 504, in some embodiments, may correspond to a specific bank of gaming devices 108 or the cluster of gaming devices 504 may be dynamically created/selected based on player 112 activity within the casino. For instance, particular and similar wagers placed by players 112 at different gaming devices 108 may cause the synchronization server 120 to consider each of the gaming devices similar. In such a situation, the synchronization server 120 may determine that gaming devices 108 should be controlled similarly because each of the players 112 in proximity to the gaming devices 108 have a similar rooting interest in a wagered event. Thus, when an outcome occurs during the wagered event, the gaming devices 108 in proximity with the players 112 that placed similar wagers may be controlled to produce a synchronized output. The synchronization server 120 may control the cluster of gaming devices 504 in a relatively efficient manner by using a broadcast excitement message 508. The broadcast excitement message 508 may correspond to a common message transmitted to each gaming device 108 in the cluster of gaming devices 504. Each gaming device 108 in the cluster of gaming devices 504 may utilize their excitement management instruction set 234 to appropriately respond and produce an output based on the common excitement message. It should be appreciated that the outputs produced by each gaming device 108 in the cluster of gaming devices 504 may not necessarily be the same if the output devices of each gaming device 108 are not the same. Said another way, each gaming device 108 may respond to the same broadcast excitement message 508 differently based on the capabilities/output devices of each gaming device 108.

FIG. 5B illustrates a further architecture that can be used to control a plurality of gaming device 108 substantially simultaneously in accordance with at least some embodiments of the present disclosure. The architecture depicted in FIG. 5B illustrates a casino floor map 516 that shows a plurality of gaming devices 108 distributed across the map 516 based on the actual location of the gaming devices 108 in a physical casino floor. In this embodiment, a game management system 116 is used to collect information regarding wagers placed at various gaming devices 108 by players 112. This information may be provided to the synchronization server 120, which determines whether certain gaming devices 108 can be clustered to a first cluster of gaming devices 520 or a second cluster of gaming devices 524.

Alternatively or additionally, the event management system 124 may be configured to determine the nature of wagers placed by players 112 at gaming devices 108 (e.g., if the wagers are placed on an event rather than games played at the gaming devices 108). In such a situation, information regarding the wagers placed by players 112 on the event (e.g., a sporting event) may be communicated to the synchronization server 120, which can then identify groups of players 112 that have common rooting preferences by executing of the mood analysis instruction set 332. The synchronization server 120 may also be configured to determine which gaming devices 108 are in proximity with an identified group of players 112 having a common rooting preference and then join the gaming devices 108 into a common cluster of gaming devices 520, 524. Thus, when a particular outcome occurs in an event, the synchronization server 120 may instruct gaming devices 108 in one cluster 520 to produce a first type of output (e.g., to match a mood of the players 112 in proximity therewith) while simultaneously instructing gaming devices 108 in another cluster 524 to produce a second type of output (e.g., to match a mood of the other players 112 in proximity therewith). This may allow the synchronization server 120 to create cheering sections in the casino based on controlling outputs of the different gaming devices 108 in the different clusters 520, 524. Moreover, players 112 may be attracted to certain gaming devices 108 and not other gaming devices 108 by recognizing that certain clusters of gaming devices 108 are producing outputs that match (or don't match) the player's current mood.

Additionally, the synchronization server 120 may have information describing a location of certain gaming devices 108 or clusters of gaming devices 520, 524 relative to a display device 512 in the casino floor. This information can be displayed on the casino map 516 and may also be used to determine which gaming devices 108 should be included in particular gaming device clusters 520, 524. For instance, gaming devices 108 that are closer to a display device 512 that is streaming a video feed from a home team's broadcast of a sporting event may have their outputs matched to a mood of home team fans whereas gaming devices 108 that are closer to another display device 512 that is streaming a video feed from the away team's broadcast of the same sporting event may have their outputs matched to the mood of the away team fans. In this way, different sections of the casino floor can be customized to produce different outputs that match a mood of players 112 in proximity therewith.

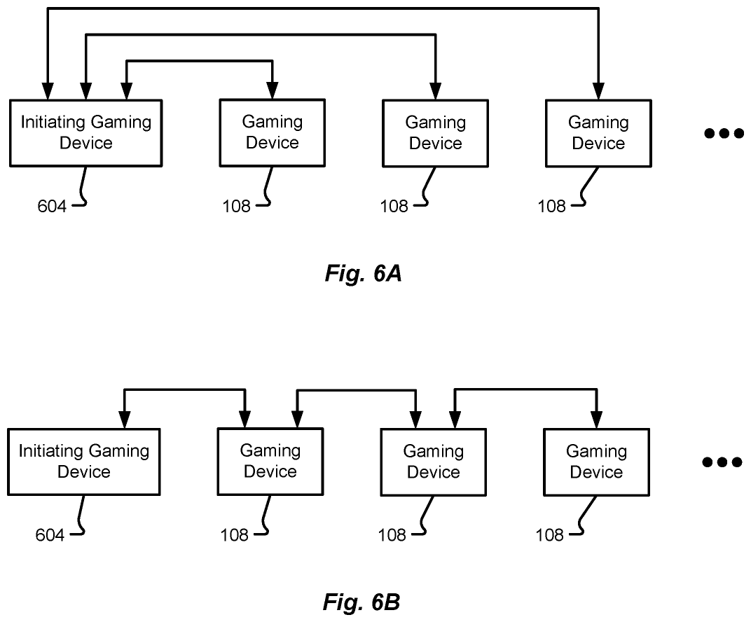

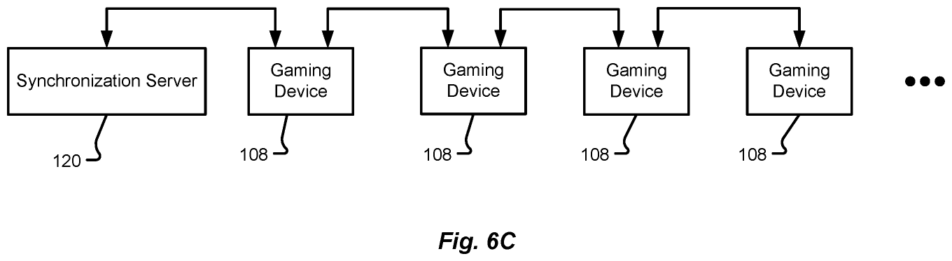

FIGS. 6A and 6B illustrate architectures where one gaming device 108 is operated as an initiating gaming device 604 and other gaming devices 108 are subordinate/slaves to the commands issued by the initiating gaming device 604. In some embodiments, an initiating gaming device 604 may correspond to a gaming device 108 that receives a winning sports wager ticket from a player 112. In some embodiments, an initiating gaming device 604 may correspond to a gaming device 108 that is determined to be in proximity with a player 112 that has just won a wager on an event, lost a wager on an event, presented a winning ticket, been issued a winning ticket, won a game of chance, lost a game of chance, etc. In the architecture of FIG. 6A, the initiating gaming device 604 may be configured to generate one or more excitement messages and transmit the excitement messages (either individually or via a broadcast) to a plurality of other gaming devices 108. The other gaming devices 108 may respond to the excitement message, when received, as if the excitement message originated from a synchronization server 120.

In the architecture of FIG. 6B, the excitement message may be serially passed from the initiating gaming device 604 to one other gaming device 108. Each gaming device 108 may pass the excitement message along to at least one other gaming device in a daisy chain fashion until the excitement message has been distributed to all desired gaming devices 108.

FIG. 6C illustrates an architecture similar to FIG. 6B, except that the excitement message does originate from a synchronization server 120. In this particular embodiment, the synchronization server 120 may communicate with a single gaming device 108 and the single gaming device 108 may transfer the excitement message to another (e.g., neighboring gaming device 108) device until all desired gaming devices 108 have received the excitement message. As will be described herein, depending upon the architecture, the excitement message may be formatted with certain synchronization parameters. For instance, if an excitement message is broadcast to a plurality of gaming devices 108, then each gaming device 108 may be configured to produce an output nearly immediately upon receiving the excitement message. On the other hand, if an architecture like the ones depicted in FIGS. 6A thru 6C are employed, then the excitement message may be formatted with information describing a certain time that each of the gaming devices 108 should produce an output. The certain time may be defined relative to a shared clock or with a defined delay set to begin upon receipt of the excitement message.

### Methods

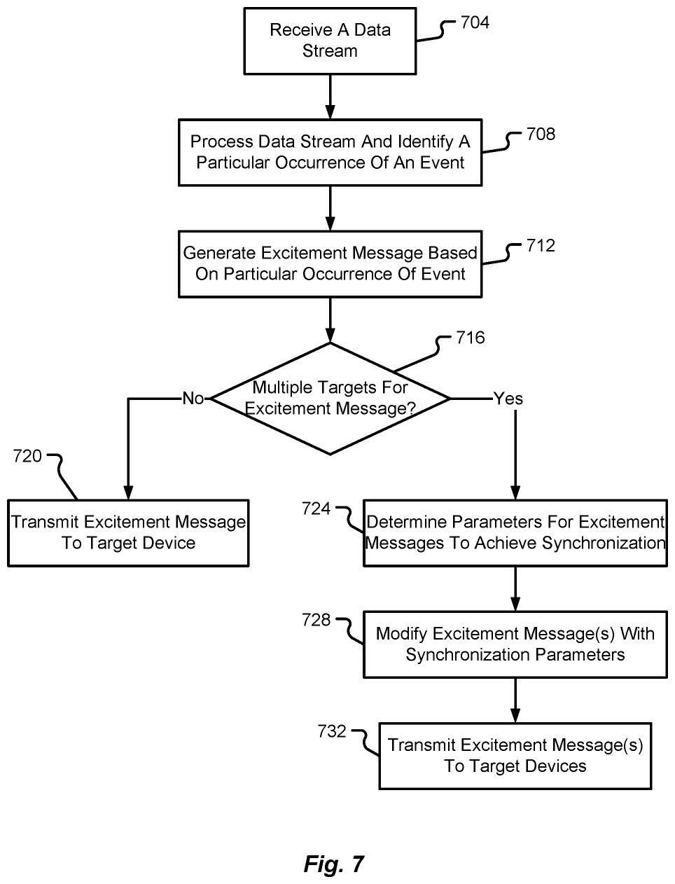

With reference now to FIGS. 7 thru 11, various methods will be described in accordance with at least some embodiments of the present disclosure. The various methods depicted and described herein may be performed with some or all of the system 100 components and should not be construed as being required to be performed within a particular system 100 component.

Referring initially to FIG. 7, a first method will be described in accordance with at least some embodiments of the present disclosure. The method begins by receiving a data stream that includes data signals encoded thereon (step 704). The data stream may be received at a synchronization server 120 or a gaming device 108. The data stream may be received at a data port or any other device known to be included in a network interface of the device that receives the data stream. In some embodiments, the data stream may include a continuous or non-continuous flow of data objects (e.g., data packets, messages, etc.).

The method continues with the receiving device utilizing its processor to process the data stream and identify a particular occurrence of an event from the data encoded on the data stream (step 708). In some embodiments, the particular occurrence of an event may correspond to the existence of an event itself or to an outcome that occurs during an event. As discussed herein, an event may correspond to any type of sporting matches, games, races (e.g., horse races, dog races, political races, etc.), competitions, boxing events, fighting events (e.g., boxing, MMA, wrestling, judo, karate, etc.), entertainment events, organized events, shows, combinations thereof, and/or discrete wagering opportunities on incidents associated with the same. Alternatively or additionally, events may correspond to one or more actions or activities that occur at a gaming device 108 (e.g., ticket-in events, win events, wager events, etc.).

The method may then continue with the receiving device utilizing its processor and possibly a different instruction set to generate one or more excitement messages based on the particular occurrence of the event (step 712). The excitement message(s) may be generated in an attempt to synchronize outputs of gaming devices 108 or substantially enhance a presentation of the event at a display device that is separate from the gaming devices 108 but on the same casino floor as the gaming devices 108. In some embodiments, the excitement message may be generated to include one or more parameters that define actions to be taken by a device that receives the excitement message. Such actions may correspond to device outputs that are audible and/or visible to a player 112 within proximity of the device.

The method may then continue by determining whether there is a single target or multiple targets for the excitement message (step 716). If there is only a single target device desired for the excitement message, then the method continues by transmitting the excitement message to the identified target device (step 720). In some embodiments, the target device may correspond to a particular gaming device 108 within a casino. The particular gaming device 108 may be selected based on a proximity with a player 112 that has placed a wager or otherwise expressed an interest in an event being displayed in proximity with the gaming device 108. Alternatively or additionally, the target device may be selected based on the type of event that has occurred and a desired audience for the enhanced display of the event.

Referring back to step 716, if the query determines that multiple target devices are desired, the method will continue with the processor determining parameters to be included in the excitement message(s) that will achieve a synchronization between recipient devices and/or a synchronization between the outputs produced by recipient devices and a presentation of the event that triggered by generation of the excitement messages (step 724). The parameters that may be included in the excitement messages may include delay parameters, clock parameters, instructions to produce an output immediately upon receipt of the excitement message, or combinations thereof. Other parameters that may be included in the excitement message may include parameters that define or prescribe the output to be produced by the receiving device, output devices to be used in connection with producing the audible/visible output, settings to be applied at the output devices when producing the audible/visible output, or combinations thereof.

If multiple different excitement messages are being transmitted to different target devices, then the method may include a step of modifying one or more of the different excitement messages with a synchronization parameter that enables each recipient device to synchronize its output with the outputs produced by other recipient devices, even if those devices did not receive the same excitement message or if the devices did not receive an excitement message at substantially the same time (e.g., due to network delays). As discussed above, the synchronization parameters may reference a common clock, a delay parameter, or the like to enable each recipient device to produce a substantially synchronized output.

The method will then continue by transmitting the multiple excitement messages to the different target devices (step 732). Again, different excitement messages may be transmitted to different target devices. Alternatively, a common or generic excitement message may be broadcast to the multiple target devices without departing from the scope of the present disclosure. The excitement messages may be transmitted to the target devices to enable the devices to perform an action consistent with parameters defined within the excitement message.

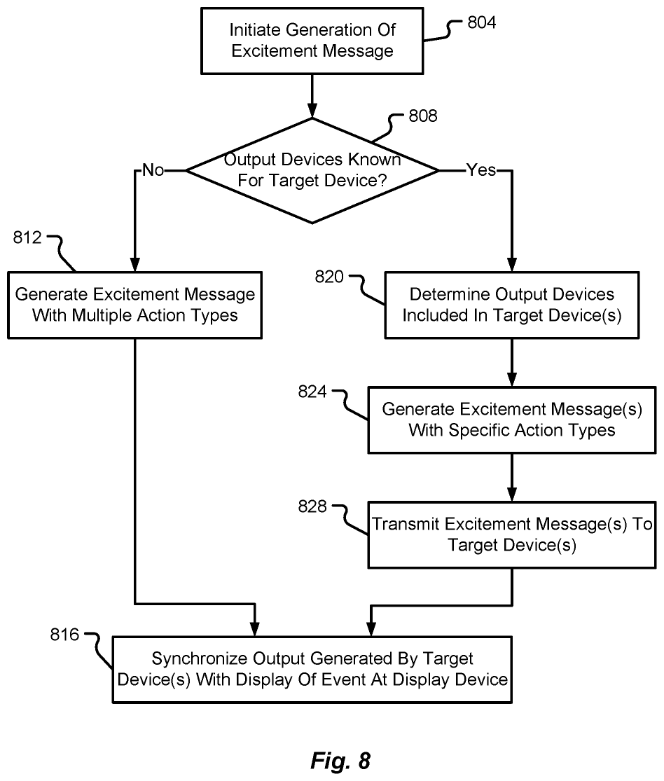

With reference now to FIG. 8, a second method will be described in accordance with at least some embodiments of the present disclosure. The method begins when an excitement message is being generated (step 804) and continues by determining whether output devices are known for a target device (step 808). In some embodiments, this query may be answered positively if the device generating the excitement message is maintaining gaming device capabilities 328 as described herein. Although the gaming device capabilities 328 were described as being stored in memory 308 of the synchronization server 120, it should be appreciated that the gaming device capabilities 328 can be stored in memory 208 of a gaming device 108 without departing from the scope of the present disclosure.

If output devices are not known for the target device (e.g., for a particular gaming device 108), then a generic excitement message may be generated that includes parameters defining multiple actions types to be taken by the recipient device (step 812). The multiple different actions may be defined based on output devices that could be included in the recipient device. If the recipient device does not have an output device defined in the excitement message, then the recipient device will simply not produce the associated output; however, if the recipient device does have an output device defined in the excitement message, then the recipient device will utilize its output device to produce the associated output defined in the excitement message. In some embodiments, the output(s) produced by the recipient device may be synchronized with the display of the event at a separate display device (step 816). In some embodiments, the outputs produced by the recipient device may be synchronized with the display of the event that triggered the generation of the excitement message.

Referring back to step 808, if it is determined that multiple target devices exist, then the method continues by determining the output devices that are included in the target devices (step 820). This determination may be made with reference to gaming device capabilities 328 stored in local memory.

The method will then continue by employing a processor to generate excitement message(s) with specific action types based on the determined output devices of the target device (step 824). For instance, gaming devices 108 known to include RBG LEDs may be instructed to flash each of the colors of LEDs in a particular sequence via parameters in the excitement messages transmitted to those gaming devices 108 whereas other gaming devices 108 known to include an LCD display may be instructed to flash the entire screen in a similar sequence of colors.

Each excitement message may then be transmitted to the particular target device having the known output devices (step 828). The excitement messages transmitted to each target device may be unique to that target device or may be common to all target devices having similar types of output devices. Thus, groups of target devices known to have similar or identical output devices may be provided with the same excitement message.

Like the transmission of a generic excitement message, the device-specific excitement messages may be transmitted to target devices in an attempt to synchronize the outputs produced by each recipient device with a display of the event that triggered by generation of the excitement messages (step 816). Again, the primary display of the event may be on a display device 512 that is physically separated from any gaming device 108 or target device.

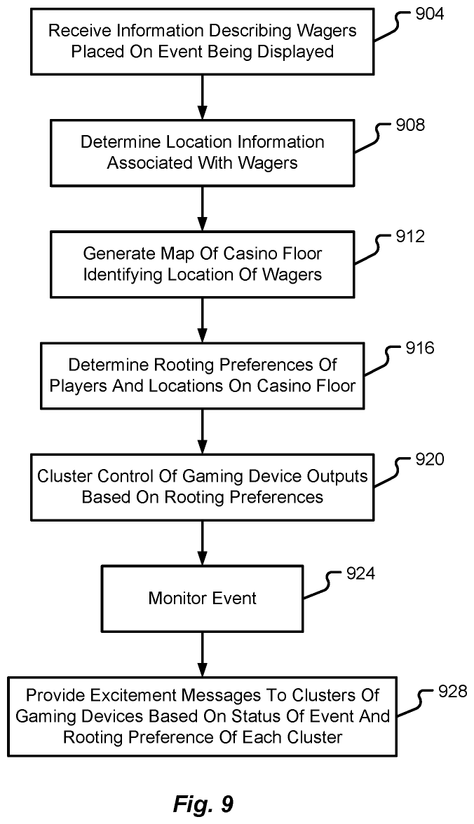

With reference now to FIG. 9, a third method will be described in accordance with at least some embodiments of the present disclosure. The method begins by receiving information describing wagers placed on an event being displayed via a display device 512 (step 904). The information describing wagers placed on the event may be received from an event management system 124 that is managing the placement of wagers for the event. Alternatively or additionally, the information describing wagers placed on the event may be received from the game management system 116 or directly from a device at which the wager was placed (e.g., from a gaming device 108 at which the player 112 placed the wager on the event).

The method may then continue by determining location information associated with the various wagers placed on the event (step 908). The location information may be determined relative to gaming devices 108, relative to physical locations in a casino, relative to a sports desk where events are being displayed and odds associated with events are being displayed, etc. In some embodiments, the location information may include an identification of a gaming device 108 at which a wager was placed by a player 112 on the event and the location of the gaming device 108 may already be known or laid out on a casino map 516.

The method may then continue by generating a map of the casino floor 516 that identifies the location of the wagers (step 912). In some embodiments, the location of the wagers may correspond to a location of gaming devices 108 at which wagers were placed. Alternatively or additionally, the location of the wagers may correspond to a known location of a player 112 regardless of whether or not the player 112 is within a predetermined proximity of a gaming device 108 (e.g., if the player 112 is sitting in a sports book and is more than a predetermined distance away from a gaming device 108).

The method may then continue by determining rooting preferences of players 112 and the locations associated with such rooting preferences (step 916). In some embodiments, the determination of rooting preferences for players 112 and their locations may enable the synchronization server 120 to identify clusters of players 112 and, therefore, clusters of gaming devices 520, 524 that are in proximity with the cluster of players 112 having common rooting preferences. If such clusters of gaming devices 520, 524 can be identified, then the synchronization server 120 may be configured to start controlling or managing outputs produced by the cluster of gaming devices 520, 524 rather than controlling outputs for individual gaming devices 108 (step 920). When clusters of gaming devices 520, 524 have been identified as being in proximity with a player 112 or group of players 112 having common rooting preferences, the synchronization server 120 may monitor the event (e.g., by subscribing to event outputs of the event management system 124) and outcomes that occur during the event (step 924). By monitoring the event and outcomes thereof and by knowing the rooting preferences of players 112, player groups, and their locations, the synchronization server 120 can be configured to provide excitement messages to clusters of gaming devices 520, 524 based on the ongoing status of the event and based on the rooting preferences of players 112 near such clusters (step 928).

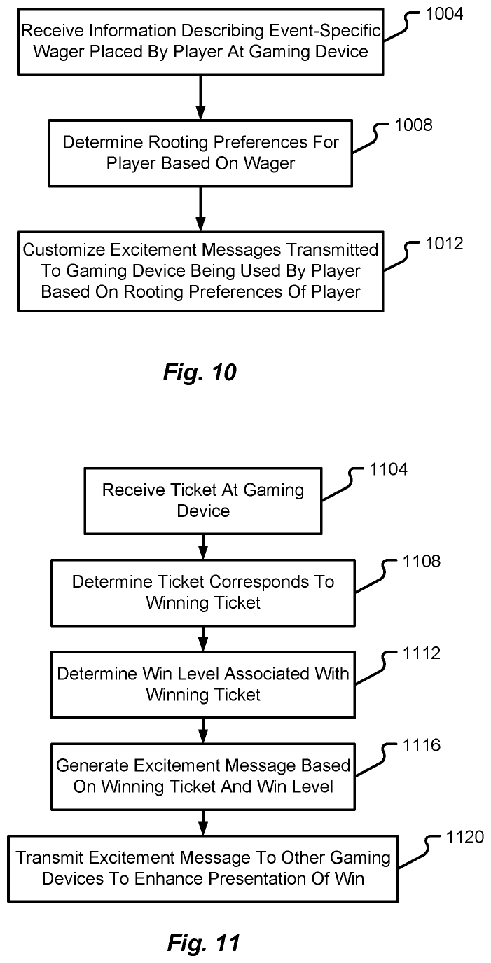

With reference now to FIG. 10, a fourth method will be described in accordance with at least some embodiments of the present disclosure. The method begins by receiving information describing event-specific wager(s) placed by a player 112 at a gaming device 108 (step 1004). The event-specific wagers(s) may correspond to wagers placed on a particular team or person to win the event, wagers placed on a particular team or person to lose the event, wagers placed for an outcome of the event, wagers placed on a particular sequence of outcomes occurring during the event, etc.

In response to receiving the event-specific wager information, the method may continue by determining rooting preferences for the player 112 that placed the wager at the gaming device 108 (step 1008). In particular, a rooting preference may be assumed to align with a player's 112 wager resulting in a winning wager. In other words, the system may assume that a player 112 has a rooting preference that coincides with a positive outcome for their wager. The method may then continue by customizing one or more excitement messages that are transmitted to the gaming device 108 at which the player 112 is positioned based on the determined rooting preferences of the player 112 (step 1012). For instance, if an outcome of an event results in the player 112 winning a wager placed at the gaming device 108 (or elsewhere) then the gaming device 108 that is determined to be within closest proximity of the player 112 may be provided with an excitement message that enhances the excitement associated with the winning wager. It should be appreciated that the method may be expanded to transmit a customized excitement message to a plurality of gaming devices 108 that are determined to be within a predetermined proximity of the player 112 that placed the winning wager.

With reference now to FIG. 11, a fifth method will be described in accordance with at least some embodiments of the present disclosure. The method begins when a ticket is presented to a gaming device 108 (step 1104). The ticket may be received and processed by the gaming device 108 using a ticket acceptance device 270.

The method may continue by determining that the ticket corresponds to a winning ticket (step 1108). The winning ticket may correspond to a winning sports betting slip, a winning lottery ticket, a winning keno ticket, a winning bingo ticket, a coupon/voucher, or any other suitably-presented proof of purchase and wager. The method may further continue with the gaming device 108 determining a win level associated with the winning ticket (step 1112). For instance, the gaming device 108 may determine an amount of money won in connection with the wager placed on the ticket, odds associated with the winning wager, whether or not the winning amount is a jackpot or maximum win amount, etc. In some embodiments, if the win level associated with the winning ticket exceeds a particular win threshold, then a higher level of celebration may be desired and appropriate actions may be taken in connection with generating and transmitting excitement message(s). For instance, higher win levels may cause the gaming device 108 to transmit the excitement message(s) to more target devices than if the winning ticket had a lower win level. Alternatively or additionally, if the winning ticket impacts more than just the player 112 presenting the ticket to the gaming device 108 (e.g., if a progressive jackpot has been won by the player 112), then a higher win level may be determined for the ticket.

The method will continue with the gaming device 108 generating one or more excitement messages based on the winning ticket and based on the win level associated with the ticket (step 1116). The message(s) may then be transmitted to other gaming devices to enhance the presentation of the win (step 1120). It should be appreciated that the outputs produced by the other gaming devices 108 may be synchronized with the outputs produced by the gaming device 108 that received the winning ticket and/or synchronized with an event that is being displayed on a separate display device 512 and that was the subject of the winning wager/ticket.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A synchronization server, comprising:
a data port that interfaces with a network used for communication with gaming devices;
a processor coupled with the data port; and
a computer-readable storage medium, coupled with the processor and comprising instructions stored thereon that are executable by the processor, wherein the instructions comprise:
a set of instructions that process data signals received at the data port and identify a particular occurrence of an event based on processing the data signals;
a set of instructions that generate an excitement message based on the particular occurrence of the event; and
a set of instructions that transmit the excitement message to a gaming device thereby enabling the gaming device to perform an action based on receiving the excitement message.

2. The synchronization server of claim 1, wherein the action is performed at the gaming device within a predetermined amount of time of identifying the particular occurrence of the event such that a presentation of the particular occurrence of the event at a display device is enhanced by the gaming device performing the action.

3. The synchronization server of claim 2, wherein the excitement message comprises a list of possible actions to be performed by the gaming device, wherein the list of possible actions correlates an output device type with an action type, and wherein the gaming device performs the action based on output devices included in the gaming device that are listed as part of the output device type in the list of possible actions.

4. The synchronization server of claim 2, wherein the instructions further comprise:
a set of instructions that determine output devices included in the gaming device; and
a set of instructions that modify the excitement message with specific action types for the gaming device that are based on the determined output devices included in the gaming device.

5. The synchronization server of claim 1, wherein the event comprises a player presenting a winning ticket to another gaming device that is connected to the network and wherein the instructions further comprise:
a set of instructions that determine a win level associated with the winning ticket and enable the excitement message to be generated based on the win level associated with the winning ticket.

6. The synchronization server of claim 1, wherein the event comprises a sporting event, wherein the data signals are received from a sports wagering management server, and wherein the instructions further comprise:
a set of instructions that determine a mood associated with the sporting event and enable the excitement message to be generated based on the mood associated with the sporting event.

7. The synchronization server of claim 6, wherein the set of instructions that determine the mood associated with the sporting event are further configured to determine a rooting preference associated with a population of players in proximity with the gaming device and enable the excitement message to be generated based on the rooting preference associated with the population of players in proximity with the gaming device.

8. The synchronization server of claim 7, wherein the rooting preference associated with the population of players in proximity with the gaming device is determined, at least in part, based on a determination of wagers placed by the population of players in proximity with the gaming device on the sporting event.

9. The synchronization server of claim 1, wherein the action performed by the gaming device includes an audible action and a visible action.

10. A gaming device, comprising:
a data port that interfaces with a network;
an output device;
a processor coupled with the data port and the output device; and
a computer-readable storage medium, coupled with the processor and comprising instructions stored thereon that are executable by the processor, wherein the instructions comprise:
a set of instructions that receive an excitement message via the data port, wherein the excitement message identifies an action for the gaming device to perform with the output device, and wherein the excitement message correlates the action to a particular occurrence of an event; and
a set of instructions that cause the output device to perform the action.

11. The gaming device of claim 10, wherein the instructions further comprise:
a set of instructions that detect an occurrence of an additional event at the gaming device;
a set of instructions that generate an additional excitement message based on the occurrence of the additional event; and
a set of instructions that transmit the additional excitement message to another gaming device thereby enabling the another gaming device to perform an additional action based on receiving the additional excitement message.

12. The gaming device of claim 11, wherein the additional event comprises a player presenting a winning ticket to the gaming device.

13. The gaming device of claim 12, wherein the additional excitement message comprises an indication of a win level associated with the winning ticket and instructions that specify the additional action based on the win level.

14. The gaming device of claim 13, wherein the additional excitement message is transmitted to a plurality of gaming devices via the data port and causes the plurality of gaming devices to perform the additional action with a defined synchronization.

15. The gaming device of claim 11, wherein the instructions further comprise:
a set of instructions that receive a wager from a player for a sporting event;
a set of instructions that determine a rooting preference for the player based on the wager received from the player for the sporting event; and
a set of instructions that customize the action performed by the output device based on the determined rooting preference for the player.

16. The gaming device of claim 15, wherein the action is performed with the output device within a predetermined amount of time of receiving the excitement message to enhance a presentation of the event via a display device.

17. A method, comprising:
receiving, at a processor, a data stream;
processing, with the processor, the data stream and identifying a particular occurrence of an event based on processing the data stream;
generating, with the processor, an excitement message based on the particular occurrence of the event; and
transmitting, via a data port in communication with the processor, the excitement message to a gaming device thereby enabling the gaming device to perform an action based on receiving the excitement message.

18. The method of claim 17, further comprising:
determining output devices included in the gaming device; and
generating the excitement message with specific action types for the gaming device that are based on the determined output devices included in the gaming device.

19. The method of claim 18, further comprising:
receiving, at the processor, information describing wagers placed on the event by a plurality of different players in proximity with the gaming device; and
displaying a map of a casino floor that identifies a location of gaming devices at which the wagers were placed along with information describing whether the wagers correspond to winning wagers or losing wagers.

20. The method of claim 19, further comprising:
determining, with the processor, a rooting preference for the plurality of different players; and
causing a plurality of different gaming devices to perform the action consistent with the rooting preference.
